(19) United States
(12) Patent Application Publication
(10) Pub. No.: US 2014/0125922 A1
(43) Pub. Date: May 8, 2014

(54) BACKLIGHT DEVICE AND LIQUID-CRYSTAL DISPLAY DEVICE COMPRISING SAID BACKLIGHT DEVICE

(71) Applicant: Kentaro Terashima, Osaka (JP)

(72) Inventor: Kentaro Terashima, Osaka (JP)

(73) Assignee: SHARP KABUSHIKI KAISHA, Osaka (JP)

(21) Appl. No.: 14/124,185

(22) PCT Filed: May 30, 2012
(86) PCT No.: PCT/JP2012/063934

§ 371 Date: Dec. 5, 2013

(30) Foreign Application Priority Data
Jun. 9, 2011 (JP) 2011-129337

(51) Int. Cl. F21V 8/00

(52) U.S. Cl. CPC G02B 6/0011
USPC 349/65

(57) ABSTRACT

An edge-light type backlight device includes: a light guide plate that is housed in a frame-shaped member; a long wiring substrate 60 that is positioned at least on one side face of the light guide plate; a plurality of point-shaped light sources 80 that are positioned in the wiring substrate 60; and a rectangular heat spreader 70 that is positioned along the wiring substrate 60 and that dissipates the heat of the wiring substrate 60. The wiring substrate 60 and the heat spreader 70 are fixed to each other by screws 65 that are disposed on both ends in the lengthwise direction of the heat spreader 70, and are adhered to each other via a double-sided adhesive tape 75 that is positioned in the central portion of the heat spreader 70 in the lengthwise direction thereof.

### TECHNICAL FIELD

The present invention relates to a backlight device having light sources for illuminating a liquid crystal display panel, and a liquid crystal display device including this backlight device. Specifically, the present invention relates to an edge-lit backlight device including a light guide plate.

The present application claims priority to Patent Application No. 2011-129337 filed in Japan on Jun. 9, 2011, the entire contents of which are hereby incorporated by reference.

### BACKGROUND ART

A liquid crystal display device includes a liquid crystal display panel having a pair of transparent substrates and liquid crystal sealed therebetween, and a backlight device disposed on the rear surface side of the panel. In the liquid crystal display device, light emitted from light sources in the backlight device is radiated onto the liquid crystal display panel from the rear surface side thereof. As a result, images displayed in the liquid crystal display panel become viewable. In the backlight device, one example of an arrangement of light sources is the so-called edge-light type (also referred to as the edge-light system), in which light sources (light-emitting diodes, for example) are disposed along an edge of a light guide plate (in other words, an edge of the liquid crystal display panel) that converts light from the light sources into planar light.

In an edge-lit backlight device, a heat-dissipation plate (a heat spreader, for example) that disperses heat from a wiring substrate (typically heat generated by light sources) is disposed on a rear surface of the wiring substrate on which a plurality of point light sources are disposed (mounted), for example. In such a case, it is difficult to use a large heat-dissipation plate due to space restrictions, and thus, it becomes important to have the heat-dissipation plate with a restricted area to be in contact with the wiring substrate in order to improve heat-dissipation properties. As a technique of this type, Patent Document 1 discloses a technique in which the heat-dissipation plate is screwed onto the substrate having the light sources. Patent Document 2 discloses a plasma display panel (PDP) including a heat-dissipation plate.

### RELATED ART DOCUMENTS

### Patent Documents

Patent Document 1: Japanese Patent Application Laid-Open Publication No. 2006-18175

Patent Document 2: Japanese Patent Application Laid-Open Publication No. 2004-38173

### SUMMARY OF THE INVENTION

### Problems to be Solved by the Invention

As a method to attach a heat-dissipation plate (typically a heat spreader) onto the wiring substrate having a plurality of point light sources thereon, there is a method in which the wiring substrate and the heat-dissipation plate are fixed to each other by screws, for example. When screwing together a long printed circuit (having a lengthwise direction of 20 cm or greater, for example) and a heat-dissipation plate, there is a risk that the wiring substrate and the heat-dissipation plate would move apart from each other in the central portion of the wiring substrate, and thus, it is necessary to screw both edges including the central portion. This risks an increase in the number of screwing steps and a decrease in the number of point light sources that can be mounted onto the wiring substrate while securing positions for screws. On the other hand, if fixing the wiring substrate and the heat-dissipation plate together by double-sided adhesive tape, it is necessary to bond the double-sided adhesive tape to the wiring substrate or the heat-dissipation plate with a high degree of accuracy from the beginning. Thus, it becomes difficult to attach the tape, the longer the wiring substrate is, and thus, there is a risk that the yield would decrease due to errors in attaching the tape, tape stretching, or the like.

The present invention is made in order to solve the above-mentioned problems of conventional configurations, and an object thereof is to provide a backlight device in which the wiring substrate is reliably fixed to the heat-dissipation plate without decreasing the number of light sources disposed on the wiring substrate, and conducting heat generated by the light sources to the heat-dissipation plate.

### Means for Solving the Problems

In order to accomplish the above-mentioned object, according to the present invention, an edge-lit backlight device of the configuration below is provided. In other words, the edge-lit backlight device of the present invention includes: a light guide plate housed in a frame-shaped member; a long wiring substrate disposed along at least one side face of the light guide plate; a plurality of point light sources disposed on the wiring substrate with a prescribed gap therebetween (typically equidistant) along a lengthwise direction of the wiring substrate; and a long heat spreader (heat-dissipation plate) disposed along the wiring substrate, the heat spreader dissipating heat from the wiring substrate. The wiring substrate and the heat spreader are fixed to each other by screws provided on both ends in a lengthwise direction of the heat spreader, and the wiring substrate and the heat spreader are also bonded to each other through a double-sided adhesive tape disposed in a central portion of the heat spreader in the lengthwise direction.

In the present specification, “screw” is a general term referring to a rod-shaped fixing member for fixing two members to each other by screw (bolt), and is not limited to a specific shape (both a type in which a cylindrical or conical shaped surface has spiral grooves, and a type in which the rod-shaped fixing body is split into two are included). Metal rod-shaped fixing members that are typically referred to as screws, bolts, male screws, rivets, and the like are all included under the term “screw.”

In the present specification “double-sided adhesive tape” refers to a belt-shaped or sheet-shaped member having adhesive layers on both surfaces thereof.

In the edge-lit backlight device provided by the present invention, the wiring substrate and the heat spreader are fixed to each other by screws on both ends of the heat spreader, and at the central portion of the heat spreader, the wiring substrate and the heat spreader are fixed to each other by the double-sided adhesive tape.

According to this configuration, the fixing of the wiring substrate and the heat spreader by screws is performed only on both ends of the heat spreader (typically also both ends of the wiring substrate). Thus, compared to a case in which the central portion of the heat spreader is additionally fixed by screws, the number of point light sources disposed (mounted) between the screws of the wiring substrate is increased. The fixing of the wiring substrate and the heat spreader by double-sided adhesive tape is only performed in the central portion of the heat spreader (typically also the central portion of the wiring substrate). Thus, it becomes easier to handle the double-sided adhesive tape when bonding the double-sided adhesive tape to the heat spreader or the wiring substrate, and it is possible to sufficiently guarantee that the heat spreader and the wiring substrate are bonded to each other in the central portion of the heat spreader. As a result, it is possible to guarantee that the wiring substrate and the heat spreader are bonded together without decreasing the number of point light sources disposed on the wiring substrate while conducting heat from the wiring substrate (typically heat generated by the point light sources) to the heat spreader and dispersing (dissipating) it to the air.

In one preferred aspect of the backlight device disclosed herein, Lₐ/L_{b} is 0.3 to 0.7 where Lₐ is a length in the lengthwise direction of the central portion of the heat spreader where the double-sided adhesive tape is attached, the central portion being a portion of the heat spreader that excludes portions on both ends thereof where the screws are disposed (typically includes the central portion of the heat spreader in the lengthwise direction thereof), and where L_{b} is a length in the lengthwise direction of the heat spreader.

A double-sided adhesive tape having such lengths can reduce defects such as bonding errors due to the ease with which the tape and the heat spreader (or wiring substrate) are attached to each other. Also, even if the bonding strength of the heat spreader and the wiring substrate is insufficient if only using screws, the bonding strength can be sufficiently guaranteed by the double-sided adhesive tape when attaching the double-sided adhesive tape to the central portion of the heat spreader (or wiring substrate).

In another preferred aspect of the backlight device disclosed herein, among the plurality of point light sources disposed along the prescribed direction, a distance between adjacent point light sources is at most 10 mm for all of the plurality of point light sources.

When disposing (mounting) as many point light sources as possible on the wiring substrate, if the distance between any of the point light sources is less than 10 mm as a result of disposing the point light sources on the wiring substrate, there is no space to perform fixing by screws between the point light sources. Thus, effects of using the configuration of the present invention are especially pronounced when bonding the wiring substrate (and the heat spreader) using the double-sided adhesive tape disposed in the central portion in the lengthwise direction when having a high density of point light sources on the wiring substrate. Also, in another preferred aspect of the backlight device disclosed herein, the light sources are light-emitting diodes (LEDs).

In another preferred aspect of the backlight device disclosed herein, a length in the lengthwise direction of the wiring substrate is at least 20 cm.

When the length of the wiring substrate is longer than 20 cm, then if the wiring substrate and the heat spreader are fixed to each other only by screws provided on both ends in the lengthwise direction of the heat spreader, then there is a risk that both members move apart from each other in the central portion in the lengthwise direction of the wiring substrate (and the heat spreader), thus resulting in insufficient heat-dissipation. Thus, effects of using the configuration of the present invention are especially pronounced when bonding the wiring substrate (and the heat spreader) using the double-sided adhesive tape disposed in the central portion in the lengthwise direction when using a relatively long wiring substrate.

In another preferred aspect of the backlight device disclosed herein, a thermal conductivity of the double-sided adhesive tape is at least 0.1 W/mK (0.1 W/mK to 2 W/mK, for example).

According to this configuration, it is possible to sufficiently conduct heat from the wiring substrate (typically heat generated by point light sources) to the heat spreader through the double-sided adhesive tape.

In another preferred aspect of the backlight device disclosed herein, bonding layers of the double-sided adhesive tape include an acrylic resin as a main component thereof.

According to this configuration, the bonding layer is melted by heat generated by the point light sources and conducted to the double-sided adhesive tape, and thus, the bonding layer and the wiring substrate and the bonding layer and the heat spreader are bonded together in an excellent manner.

Also, according to the present invention, a liquid crystal display device including any of the disclosed the backlight devices is provided. The liquid crystal display device includes such a backlight device, and thus, can have excellent heat-dissipation properties by conducting heat generated by the point light sources effectively to the heat spreader and dissipating this heat from the heat spreader to the air effectively.

### BRIEF DESCRIPTION OF THE DRAWINGS

FIG. 1 is an exploded perspective view that schematically shows a structure of a liquid crystal display device of one embodiment of the present invention.

FIG. 2 is a cross-sectional view that schematically shows a structure of a liquid crystal display device of one embodiment of the present invention.

FIG. 3 is a plan view that schematically shows a backlight device of one embodiment of the present invention.

FIG. 4 is an exploded perspective view that schematically shows a wiring substrate and a heat spreader of one embodiment of the present invention.

FIG. 5 is an exploded perspective view that schematically shows a wiring substrate and a heat spreader of another embodiment of the present invention.

FIG. 6 is an exploded perspective view that schematically shows a wiring substrate and a heat spreader of another embodiment of the present invention.

Below, a number of preferred embodiments of the present invention will be explained with reference to figures. Matters not specifically mentioned herein, but necessary to implement the present invention (a configuration and assembly method for a display panel, a configuration of light sources installed in the display device, and the like, for example) can be worked out as design matters by those skilled in the art based on conventional technologies in the field. The present invention can be implemented based on the contents disclosed herein and common technical knowledge in the field.

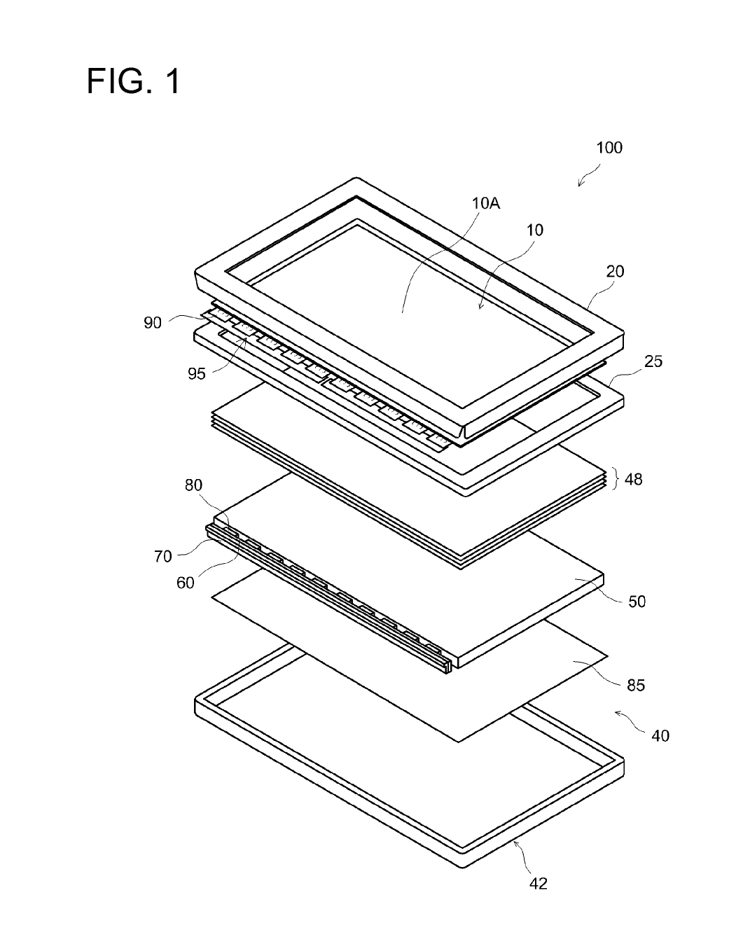

Below, with reference to FIGS. 1 to 4, a preferred embodiment (Embodiment 1) of the present invention will be explained. In the example below, an active matrix type (TFT-type) liquid crystal display device 100 that includes a liquid crystal display panel 10 as a display panel will be explained.

In the following figures, the same reference characters are given to members and portions that have the same functions, and duplicative explanations may be omitted or abridged. Also, the dimensional relationship (length, width, thickness, and the like) in each of the figures does not necessarily reflect the actual dimensional relationship accurately. In the description below, “front surface” or “front side” refers to a side facing a viewer of the liquid crystal display device 100 (that is, the side of the liquid crystal display panel 10), and “rear surface” or “rear side” refers to a side not facing the viewer of the liquid crystal display device 100 (that is, the side of a backlight device 40).

As shown in FIG. 1, the liquid crystal display device 100 includes a liquid crystal display panel 10 and a backlight device 40 that is an external light source disposed on the rear surface side of the liquid crystal display panel 10. The liquid crystal display device 10 and the backlight device 40 are assembled by a bezel (frame member) 20 or the like, thereby being held as one component.

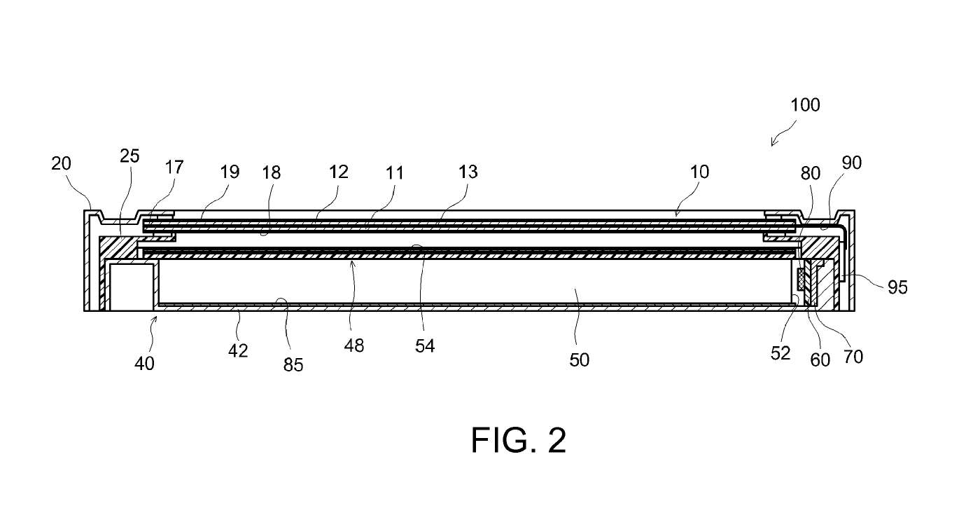

As shown in FIG. 1, the liquid crystal display panel 10 typically has a rectangular shape as a whole, and has a display region 10A in the central portion thereof. The display region 10A has pixels formed therein, and displays images. Also, as shown in FIG. 2, the liquid crystal display panel 10 has a sandwiched structure including a pair of transparent glass substrates 11 and 12 that face each other, and a liquid crystal layer 13 sealed therebetween. Of the pair of substrates 11 and 12, one on the front side is a color filter substrate (CF substrate) 12, and the other on the rear side is an array substrate 11. In the periphery of the CF substrate 12 and the array substrate 11, a sealing member 17 is provided so as to enclose the display region 10A, thereby sealing the liquid crystal layer 13. The liquid crystal layer 13 is made of a liquid crystal material that includes liquid crystal molecules. The orientation of the liquid crystal molecules is controlled by an electric field applied between the array substrate 11 and the CF substrate 12, which changes the optical characteristics of the liquid crystal material. The respective substrates 11 and 12 have alignment films (not shown) that respectively determine the orientation directions of the liquid crystal molecules on the respective surfaces facing each other (inner surfaces). On the respective surfaces not facing each other (outer surfaces), polarization plates 18 and 19 are respectively bonded.

Here, the array substrate 11 has a greater area than the CF substrate 12. When the two substrates 11 and 12 are bonded to each other, an edge of at least one side of the four sides that constitute a rectangular periphery of the array substrate 11 protrudes slightly from the CF substrate 12. As shown in FIG. 1, in the present embodiment, flexible printed circuits 90 for a panel (FPC for panel) are disposed. On each FPC 90 for a panel, a not-shown liquid crystal display panel driver IC chip (driver IC chip) for driving the liquid crystal display panel 10 is mounted. In the FPCs 90 for a panel configured in the manner described above, one end thereof is fixed to the protruding edge, thereby connecting the FPCs 90 for a panel to the electrodes (the pixel electrodes, opposite electrode, and the like) in the liquid crystal display panel 10. The other end of the FPCs 90 for a panel has attached thereto a printed circuit board 95 in which a controller for controlling the driver IC (chip) and other electronic components and the like are included. As shown in FIG. 2, such a printed circuit board 95 is folded towards the backlight device 40, and thus are disposed on a side face portion of the backlight device 40 (specifically, the side face portion of the outer circumference of the frame 25). The printed board 95 may also be disposed on the rear side of the backlight device 40.

As shown in FIGS. 1 to 3, the edge-lit backlight device 40 of the present embodiment, which is disposed on the rear surface side (rear side) of the liquid crystal display panel 10, in general includes a plurality of point light sources 80, a light guide plate 50 that converts light from the plurality of point light sources 80 into planar light, a long wiring substrate 60 that has disposed thereon the plurality of point light sources 80 along the lengthwise direction thereof with a prescribed gap between each (equidistant from each other, for example), a heat spreader (heat-dissipation plate) 70 that has a long shape and is disposed along the wiring substrate 60, a reflective sheet 85, and a chassis 42 (also referred to as a backlight chassis or a case) that is a frame-shaped member that houses all of these.

The light guide plate 50 housed in the chassis 42 is formed by injection forming or the like in a rectangular flat plate shape that is large enough to cover the display region 10A of the liquid crystal display panel 10. As shown in FIG. 2, the light guide plate 50 has a light-receiving face 52 to which light from the plurality of point light sources 80 is inputted, and a light-exiting face 54 from which this inputted light is radiated towards the liquid crystal display panel 10. There is no special limitation on the material to form the light guide plate 50 as long as it is transparent and has excellent formability. Examples of the material include an acrylic resin and a polycarbonate resin. On the bottom surface of the light guide plate 50 (rear surface facing the reflective sheet 85), a dotted pattern (not shown) is formed so as to increase the light utilization efficiency by scattering light. The dotted pattern is formed by printing using ink or the like for forming a reflective pattern or a diffusion pattern.

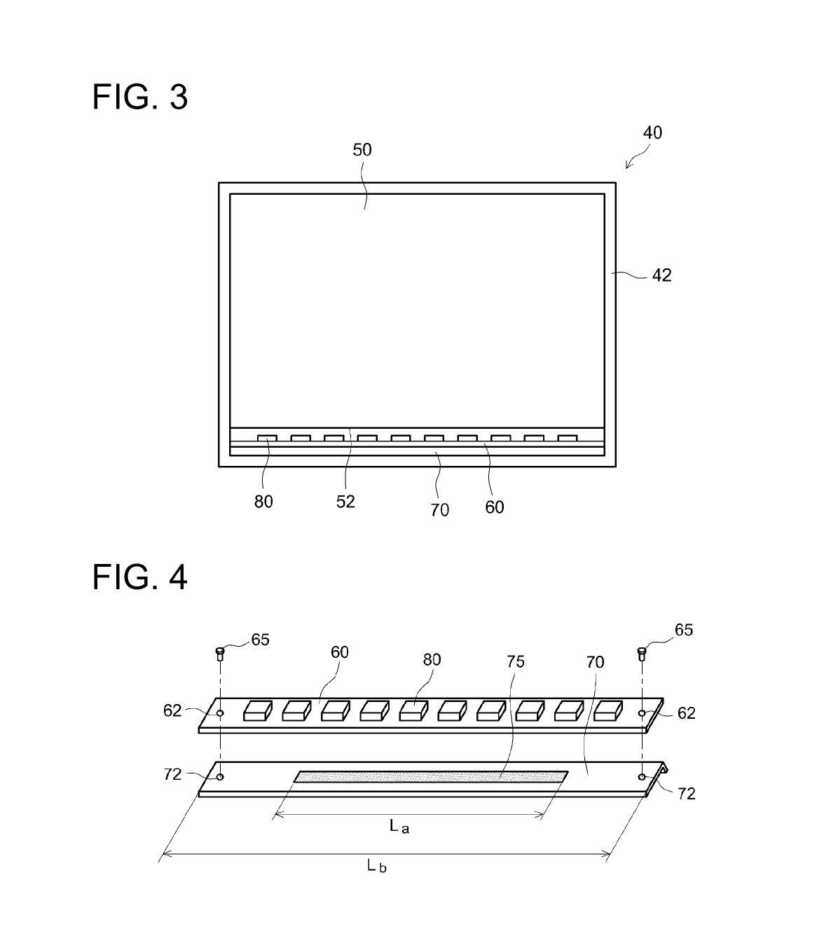

As shown in FIGS. 2 and 3, the wiring substrate 60 with a long shape is disposed in the vicinity of at least one side face (in other words, one surface of the light-receiving face 52) of the light guide plate 50. There is no special limitation on the length of the wiring substrate 60 in the lengthwise direction, but it is preferable that the length be at least 20 cm (20 cm to 60 cm, for example). Both ends in the lengthwise direction of the wiring substrate 60 of the present embodiment are respectively provided with screw holes 62 for fixing the wiring substrate 60 to the heat spreader 70 to be described later by screws 65. Also, the method for mechanically fixing the heat spreader 70 to the wiring substrate 60 on both ends in the lengthwise direction of the heat spreader 70 is not limited to the method using the screws 65 and a method similar to a conventionally known technique may be used. Examples of the screw 65 include the helical type and the press-fit type.

As shown in FIGS. 2 and 3, on the long wiring substrate 60 disposed on at least one side face of the light guide plate 50, the plurality of point light sources 80 are disposed (mounted) with prescribed gaps therebetween (typically equidistant to each other) along the lengthwise direction of the wiring substrate 60. Typically, the plurality of point light sources 80 are disposed along one row facing the light-receiving face 52 of the light guide plate 50. There is no special limitation for the distance between adjacent point light sources 80, but it is preferable that the distance be at most 10 mm (2 mm to 10 mm, for example) in all cases, for example. Light-emitting diodes (LEDs), laser diodes (LDs), VCSELs (vertical cavity surface emitting lasers), and the like are examples of point light sources 80.

The point light sources 80 are not limited to being disposed in the vicinity of one light-receiving face 52 (side face) of the light guide plate 50 as shown in FIG. 3, and may additionally be disposed in the vicinity of a face opposite to the light-receiving face 52.

As shown in FIGS. 2 and 3, the long heat spreader (heat-dissipation plate) 70 is disposed along the wiring substrate 60. There is no special limitation on the length in the lengthwise direction (size) of the heat spreader 70 as long as heat from the wiring substrate 60 (typically heat generated by the point light sources 80 disposed on the wiring substrate 60) is sufficiently dissipated, but the length of the heat spreader 70 is the same as the length in the lengthwise direction of the wiring substrate 60, for example. The heat spreader 70 is a heat-dissipation plate (heat-dissipation member) that is in contact with the wiring substrate 60 and disperses heat in the wiring substrate 60 (typically heat generated by the point light sources 80). The heat spreader 70 is made of a metal with excellent thermal conduction (aluminum, for example).

As shown in FIGS. 2 and 4, the heat spreader 70 of the present embodiment is a long member with an L-shaped cross-section, and the area of the cross-sectional face of the heat spreader 70 and the area of the cross-sectional face of the wiring substrate 60 are effectively the same. On both ends in the lengthwise direction of the heat spreader 70, screw holes 72 for fixing the heat spreader 70 to the wiring substrate 60 by the screws 65 are respectively provided.

Also, as shown in FIG. 4, the central portion of the heat spreader 70 in the lengthwise direction (typically including the central portion in the lengthwise direction of the heat spreader 70) has a double-sided adhesive tape 75 disposed (attached) thereon, and the wiring substrate 60 and the heat spreader 70 are bonded to each other by the double-sided adhesive tape. The main component of the bonding layer of the double-sided adhesive tape 75 is an acrylic resin or the like, for example. When using the double-sided adhesive tape 75 including the acrylic resin as the main component and bonding layers, during use of the backlight device 40, heat generated by the point light sources 80 is conducted to the double-sided adhesive tape 75 causing the bonding layers to melt, and thus, the bond between the bonding layer and the wiring substrate 60 and the heat spreader 70 becomes stronger.

It is preferable that the thermal conductivity of the double-sided adhesive tape be at least 0.1 W/mK (0.1 W/mK to 2 W/mK, for example). If the thermal conductivity of the double-sided adhesive tape 75 is less than 0.1 W/mK, then there is a risk that it becomes difficult for heat from the wiring substrate 60 (typically heat generated by the point light sources 80) to be conducted efficiently from the wiring substrate 60 to the heat spreader 70 through the double-sided adhesive tape 75.

As for the double-sided adhesive tape 75 of the present embodiment, as shown in FIG. 4, it is preferable that Lₐ/L_{b} be 0.3 to 0.7, where Lₐ is the length in the lengthwise direction of the central portion of the heat spreader 70 to which the double-sided adhesive tape 75 is attached, which is the central portion (typically including the central portion in the lengthwise direction of the heat spreader 70) excluding where screws 65 (where the screw holes 72 are formed) are disposed on both ends of the heat spreader 70, and where L_{b} is the length (entire length) in the lengthwise direction of the heat spreader 70. The double-sided adhesive tape 75 having the length defined above can be handled with ease when attaching the double-sided adhesive tape 75 to the heat spreader 70 or the wiring substrate 60. Thus, the occurrence of defects such as bonding errors and the like can be reduced. Also, the double-sided adhesive tape 75 having the length as described above can bond the members 60 and 70 to each other in the central portion of the heat spreader 70 and the central portion of the wiring substrate 60. Thus, by combining this bonding method with the screws 65 provided on both ends of the heat spreader 70 and both ends of the wiring substrate 60 so as to fix them together, the heat spreader 70 and the wiring substrate 60 can be attached to each other over the entirety thereof. As a result, heat generated by the point light sources 80 can be conducted efficiently to the heat spreader 70, and a backlight device 40 that has excellent heat-dissipation can be realized.

As shown in FIG. 1, in such a backlight device 40, on the front side of the light guide plate 50, which is the open portion of the chassis 42, a plurality of sheet-shaped optical sheets 48 are stacked so as to cover the open portion. The optical sheets 48 are constituted of a diffusion plate, a diffusion sheet, a lens sheet, and a brightness enhancement sheet in this order from the backlight device 40 towards the liquid crystal display panel 10, for example, but are not limited to this combination and order. Additionally, in order to hold the optical sheets 48 onto the chassis 42 in a sandwiched state, a substantially frame-shaped frame 25 is provided on the chassis 42. On the rear side of the chassis 42, an inverter circuit substrate, which is not shown, for mounting an inverter circuit thereon, and an inverter transformer, which is not shown, as a booster circuit for supplying power to the point light sources 80 are provided.

As described above, optical sheets 48 are disposed on the front side of the backlight device 40. The frame 25, which is open in the portion thereof corresponding in position to the display region 10A of the liquid crystal display panel 10, is attached to the front surface side of the optical sheets 48 so as to sandwich the optical sheets 48 between the backlight device 40 and the frame 25. The liquid crystal display panel 10 is mounted on the front surface of the frame 25. Additionally, a bezel 20 is attached to the front surface side of the liquid crystal display panel 10, thus completing the liquid crystal display device 100.

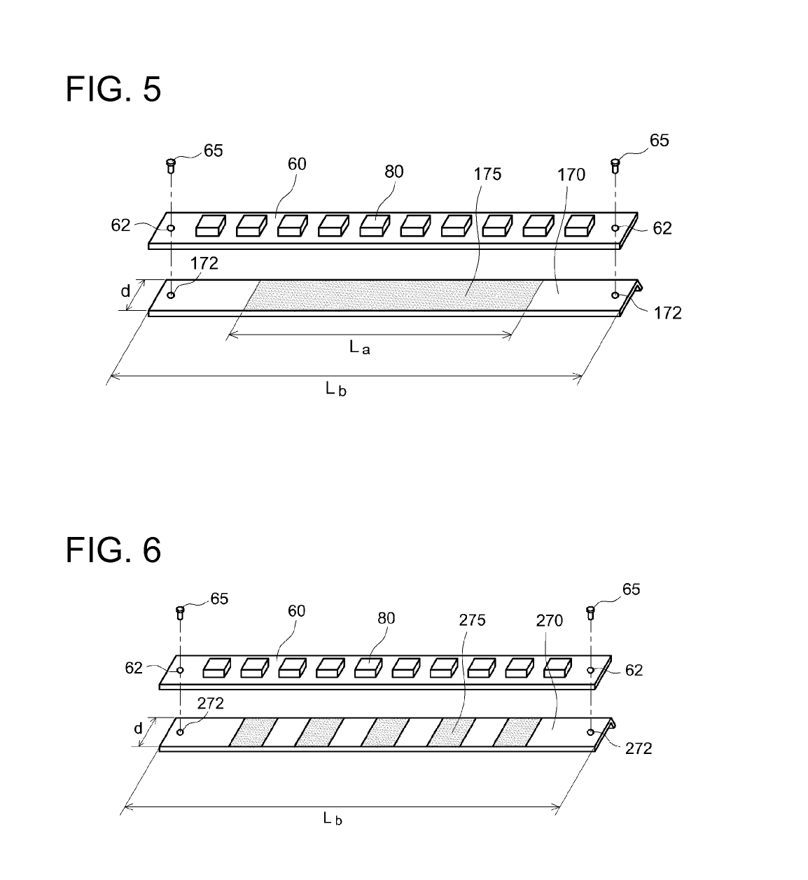

Next, with reference to FIG. 5, Embodiment 2 will be explained. FIG. 5 is an exploded perspective view that schematically shows a heat spreader 170 and a wiring substrate 60 of the present embodiment.

As shown in FIG. 5, a double-sided adhesive tape 175 is disposed (attached) to the central portion in the lengthwise direction of the heat spreader 170 (typically including the central portion in the lengthwise direction of the heat spreader 170), and the wiring substrate 60 and the heat spreader 170 are bonded to each other through the double-sided adhesive tape 175.

As shown in FIG. 5, as for the double-sided adhesive tape 175 of the present embodiment, it is preferable that S1ₐ/S1_{b} be 0.3 to 0.7 where S1ₐ (area S1ₐ=length Lₐ in lengthwise direction of double-sided adhesive tape 175×length d in the widthwise direction of the heat spreader 170) is the area of the central portion where the double-sided adhesive tape 175 is attached, which is the central portion (typically including the central portion in the lengthwise direction of the heat spreader 170) excluding the portions where the screws 65 (where the screw holes 172 are formed) are disposed on both ends of the heat spreader 170, and where S1_{b} (area S1_{b}=length L_{b} in lengthwise direction of heat spreader 170×length d in widthwise direction of the heat spreader 170) is the area of the entire heat spreader 170. By setting the size of the double-sided adhesive tape 175 by area and attaching the double-sided adhesive tape 175 with the area defined above to the heat spreader 170 or the wiring substrate 60 in this manner, effects similar to Embodiment 1 can be attained.

Next, with reference to FIG. 6, Embodiment 3 will be explained. FIG. 6 is an exploded perspective view that schematically shows a heat spreader 270 and a wiring substrate 60 of the present embodiment.

As shown in FIG. 6, on the central portion (typically including the central portion in the lengthwise direction of the heat spreader 270) in the lengthwise direction of the heat spreader 270, a plurality of double-sided adhesive tapes 275 with a prescribed gap (equidistant, for example) therebetween is disposed (attached), and the wiring substrate 60 and the heat spreader 270 are bonded to each other through the double-sided adhesive tape 275.

As shown in FIG. 6, as for the double-sided adhesive tape 275 of the present embodiment, it is preferable that S2ₐ/S2_{b} be 0.3 to 0.7 where S2ₐ (total area S3ₐ of the double-sided adhesive tapes 275) is the total area of the portion where the plurality of double-sided adhesive tapes 275 are attached, which is the central portion (typically including the central portion in the lengthwise direction of the heat spreader 270) excluding the portion where the screws 65 are disposed (area where the screw holes 272 are formed) on both ends of the heat spreader 270, and where S2_{b} (area S2_{b}=length L_{b} in the lengthwise direction of the heat spreader 270×length d in the widthwise direction of the heat spreader 270) is the total area of the heat spreader 270. By setting the size of the double-sided adhesive tape 275 by area and attaching the double-sided adhesive tapes 275 onto the heat spreader 270 or the wiring substrate 60 such that the total area of the plurality of double-sided adhesive tapes 275 is as defined above, effects similar to Embodiment 1 can be attained.

Specific examples of the present invention were described above in detail with reference to the figures, but these specific examples are illustrative, and not limiting the scope of the claims. The technical scope defined by the claims includes various modifications of the specific examples described above.

For example, in the liquid crystal display device 100 in the embodiments above, the image display portion is constituted of one liquid crystal display panel 10, but it is possible to have one image display portion (multi-display) constituted of a combination of a plurality of liquid crystal display panels 10. It is possible to use such a liquid crystal display device 100 in which the plurality of liquid crystal display panels 10 are combined as a large screen digital signage (a 100-inch or larger display device, for example).

### INDUSTRIAL APPLICABILITY

According to the present invention, even if multiple point light sources are disposed on a wiring substrate, which is a relative long wiring substrate for disposing (mounting) point light sources, it is possible to reliably fix together the wiring substrate and the heat spreader (heat-dissipation plate) without the need for reducing the number of point light sources disposed on the wiring substrate. Thus, it is possible to provide a backlight device with excellent heat-dissipation properties, in which it is possible to effectively conduct heat generated by the point light sources to the heat spreader.

### DESCRIPTION OF REFERENCE CHARACTERS

10 liquid crystal display panel
10A display region
11 array substrate
12 color filter substrate (CF substrate)
13 liquid crystal layer
17 sealing member
18, 19 polarizing plate
20 bezel (frame member)
25 frame
40 backlight device
42 chassis (frame-shaped member)
48 optical sheets
50 light guide plate
52 light-receiving face
54 light-exiting face
60 wiring substrate
62 screw hole
65 screw
70 heat spreader (heat-dissipation plate)
72 screw hole
75 double-sided adhesive tape
80 point light source
85 reflective sheet
90 FPC for panel
95 printed circuit board
100 liquid crystal display device
170 heat spreader (heat-dissipation plate)
172 screw hole
175 double-sided adhesive tape
270 heat spreader (heat-dissipation plate)
272 screw hole
275 double-sided adhesive tape

1. An edge-lit backlight device, comprising:
a light guide plate housed in a frame-shaped member;
a long wiring substrate disposed along at least one side face of the light guide plate;
a plurality of point light sources disposed on the wiring substrate with a prescribed gap therebetween along a lengthwise direction of the wiring substrate; and
a long heat spreader disposed along the wiring substrate, the heat spreader dissipating heat from the wiring substrate,
wherein the wiring substrate and the heat spreader are fixed to each other by screws provided on both ends in a lengthwise direction of the heat spreader, and the wiring substrate and the heat spreader are also bonded to each other through a double-sided adhesive tape disposed in a central portion of the heat spreader, the central portion being a portion of the heat spreader that excludes portions on both ends thereof where the screws are disposed.

2. The backlight device according to claim 1, wherein Lₐ/L_{b} is 0.3 to 0.7 where Lₐ is a length in the lengthwise direction of the central portion of the heat spreader where the double-sided adhesive tape is attached, and where L_{b} is a length in the lengthwise direction of the heat spreader.

3. The backlight device according to claim 1, wherein, among the plurality of point light sources disposed with the prescribed gap therebetween, a distance between adjacent point light sources is at most 10 mm for all of the plurality of point light sources.

4. The backlight device according to claim 1, wherein a length in the lengthwise direction of the wiring substrate is at least 20 cm.

5. The backlight device according to claim 1, wherein a thermal conductivity of the double-sided adhesive tape is at least 0.1 W/mK.

6. The backlight device according to claim 1, wherein bonding layers of the double-sided adhesive tape include an acrylic resin as a main component thereof.

7. The backlight device according to claim 1, wherein the point light sources are light-emitting diodes.

8. A liquid crystal display device, comprising the backlight device according to claim 1.
